(19) United States
(12) Patent Application Publication
(10) Pub. No.: US 2012/0242178 A1
(43) Pub. Date: Sep. 27, 2012

(54) ROTATING ELECTRICAL MACHINE

(75) Inventors: Tomohiko Miyamoto, Toyota-shi (JP); Tetsuo Wakita, Chiryu-shi (JP)

(73) Assignee: TOYOTA JIDOSHA KABUSHIKI KAISHA, Toyota-shi (JP)

(21) Appl. No.: 13/426,183

(22) Filed: Mar. 21, 2012

(30) Foreign Application Priority Data
Mar. 22, 2011 (JP) 2011-061944

(51) Int. Cl. H02K 9/19

(52) U.S. Cl. 310/54

(57) ABSTRACT

A rotating electrical machine includes: a rotor whose axis is disposed in a horizontal direction, a stator core that is disposed in an outside of the rotor, a coil that is wound in a slot which is provided along the axial direction of the stator core, whose end sections of windings protrude from a front end and a rear end of the stator core in the axial direction as coil ends and whose one end of a winding wire is drawn as a lead wire to the outside, and an annular cooling jacket. The cooling jacket has an opening through which the lead wire of the coil is drawn to the outside and the opening is provided at a predetermined height position above an upper end of the coil end as a reference position.

### INCORPORATION BY REFERENCE

The disclosure of Japanese Patent Application No. 2011-061944 filed on Mar. 22, 2011 including the specification, drawings and abstract is incorporated herein by reference in its entirety.

### BACKGROUND OF THE INVENTION

1. Field of the Invention

The present invention relates to a rotating electrical machine and more particularly to a rotating electrical machine that includes a cooling jacket which encloses a coil end of a stator.

2. Description of Related Art

The rotating electrical machine includes a rotor and a stator and rotates through an interaction between current that flows through a coil which is wound around a stator core and a magnetic pole of the rotor. The coil that is wound around the stator core produces heat by the passage of electric current therethrough, and therefore the coil is subjected to cooling.

For example, Japanese Patent Application Publication No. 2005-323416 (JP 2005-323416 A) discloses, as a cooling structure of a motor generator, a structure that includes a cooling jacket which houses a coil in a slot of a stator core, blocks an opening of the slot which is opened in an inner periphery of the stator core, and forms a liquid-tight annular space which encloses coil ends protruding respectively from a front end and a rear end of the stator core. In the disclosure of JP 2005-323416 A, it is described that an inlet of a cooling medium is disposed in a lower section of the cooling jacket, and an outlet of the cooling medium is disposed in an upper section of the cooling jacket, and therefore as the cooling medium moves upward, temperature rises, density of the cooling medium becomes low, weight is reduced, upward flow is accelerated with buoyancy, and thus the flow does not stagnate.

JP 2005-323416 A also discloses that the cooling jacket which encloses the coil end protruding from the stator core is formed as a liquid tight structure, the cooling medium is flowed, and therefore cooling is performed. Here, the coil that is wound around the stator core has a lead wire that is drawn to the outside in order to pass the electrical current. In JP 2005-323416 A, because the cooling jacket is formed to be the liquid tight structure, it is considered that a seal for the cooling jacket in drawing of the lead wire may become complicated.

### SUMMARY OF THE INVENTION

The object of the present invention is to provide a rotating electrical machine that prevents leakage of a coolant when a lead wire of a coil is drawn from a cooling jacket that encloses a coil end.

Aspects of the present invention relate to a rotating electrical machine. This rotating electrical machine includes a rotor whose axis is disposed in a horizontal direction, a stator core that is disposed in an outside of the rotor, a coil that is wound in a slot which is provided along the axial direction of the stator core, whose end sections of windings protrude from a front end and a rear end of the stator core in the axial direction as coil ends and whose one end of a winding wire is drawn as a lead wire to the outside, and an annular cooling jacket that makes a liquid-tight space between end sections in the front and rear end of the stator core in the axial direction in which the coil end and coolant oil are housed. The cooling jacket has an opening through which the lead wire of the coil is drawn to the outside and the opening is provided at a predetermined height position above an upper end of the coil end as a reference position.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a stator part in a rotating electrical machine according to an embodiment of the present invention;

FIG. 2 is a cross-sectional view of the rotating electrical machine according to an embodiment of the present invention;

FIG. 3 is a side view of the rotating electrical machine according to an embodiment of the present invention that illustrates an appearance which is seen from an end face of a stator in an axial direction;

FIG. 4 is a diagram that illustrates a setting of a height position of an opening of the cooling jacket in the rotating electrical machine according to an embodiment of the present invention;

FIG. 5 is a view that illustrates another example in which the opening is formed in the cooling jacket of the stator;

FIG. 6 is a side view of FIG. 5 that illustrates an appearance which is seen from the end face of the stator in an axial direction; and

FIG. 7 is a view that illustrates an appearance in which the opening is formed in the cooling jacket of the stator shown in FIG. 6.

### DETAILED DESCRIPTION OF EMBODIMENTS

Hereinafter, with reference to drawings, embodiments of the present invention will be described in detail. As a rotating electrical machine, the following describes a three-phase rotating electrical machine in which three phase coils of U-phase, V-phase, and W-phase are wound on a stator core and three lead wires are drawn from respective coil ends; however, such the rotating electrical machine is an example for description, and the rotating electrical machine may have other structures in which the coil end is cooled, while the lead wire that is drawn from the coil end to the outside is provided. The following also describes a rotating electrical machine that is mounted on a vehicle; however, such the rotating electrical machine is also an example for description, and the rotating electrical machine may be applicable to other usage than a vehicle mountable rotating electrical machine.

In the following description, the same reference numerals and symbols are given to the same elements in all drawings, and the descriptions are not repeated. In the description herein, the reference numerals and symbols that are described in previous description are used as needed.

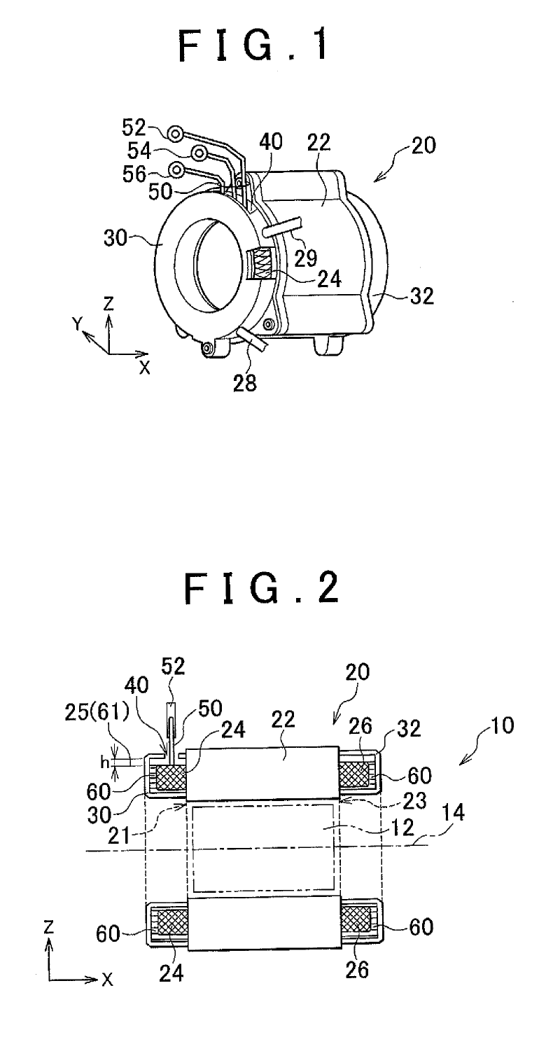

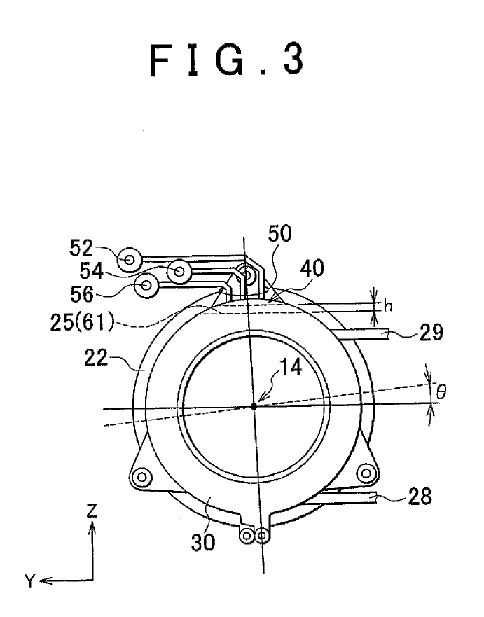

FIG. 1 through FIG. 3 are views that illustrate the structure of a stator 20 which is extracted from a vehicle mountable three-phase rotating electrical machine 10. FIG. 1 is a perspective view, FIG. 2 is a cross-sectional view, and FIG. 3 is a side view that is seen from an end face of a stator in an axial direction. As shown in FIG. 2, the rotating electrical machine 10 includes a rotor 12 and a stator 20 that is disposed in the outside of the rotor 12. An axial direction of a central axis 14 of the rotor 12 or the stator 20 is arranged in a horizontal direction. In order to illustrate the above, FIG. 1 through FIG. 3 shows directions of three axes, X-, Y-, and Z-axis that are at right angles to each other. Here, a Z-axis direction is a direction of gravitational force, an X-axis direction is a horizontal direction along the central axis 14, and a Y-axis direction is a horizontal direction that is at right angles to the X-axis. That is, the rotating electrical machine 10 is of a transverse-mounted type in which an output shaft is arranged in the horizontal direction.

The stator 20 includes a stator core 22, coil ends 24 and 26, cooling jackets 30 and 32.

The stator core 22 is constructed as a cylindrical member that corresponds to a body section of the stator 20 and formed by stacking plural magnetic steel sheets that are punched in a specified shape. The stator core 22 is provided with plural recesses in a circumferential direction which are referred to as slots that extend from an inner periphery to an outer periphery in a radial direction. The magnetic steel sheet sections between adjacent slots are referred to as teeth, and the stator coil is wound around the teeth. In the case of three-phase rotating electrical machine 10, a U-phase coil, a V-phase coil, and a W-phase coil that respectively correspond to a U-phase, a V-phase, and a W-phase are wound around the teeth of the stator core 22, that is, in the slots in a predetermined wire-wound arrangement.

The coil ends 24 and 26 refer to sections where the coil that is wound around the teeth of the stator core 22 protrude from end sections 21 and 23 on both sides of the stator core 22 in the axial direction. The coil ends 24 and 26 have a shape in which winding wires are annularly assembled on the outside of the end sections 21 and 23 of the stator core 22.

Lead wires 52, 54, and 56 are cables that are respectively drawn from one end of the U-phase coil, the V-phase coil, and the W-phase coil of the three-phase rotating electrical machine 10 to the outside. The lead wires 52, 54, and 56 are drawn from either side of the coil ends 24 and 26. As shown in FIG. 2, if an end section in −x direction of two end sections 21 and 23 on the both sides of the stator core 22 in the axial direction is referred to as a front end and an end section in +X direction is referred to as a rear end, the lead wires 52, 54, and 56 are drawn from the coil end 24 on the side of an end section 21 in the front end. When the front end and the rear end of the stator 20 in the axial direction are defined as described above, FIG. 3 shows a side view that is seen from the end section 21 in the front end. In addition, the other ends of the respective U-phase coil, V-phase coil, and W-phase coil are connected to each other to faun a neutral point.

The cooling jacket 30 is an annular member that makes a liquid-tight space between the end section 21 in the front end of the stator core 22 in the axial direction in which the coil end 24 and coolant oil 60 are housed. The annular member has a shape of an annular bath that is a half-cut toroidal shape which is hollow inside, an opening in a half-cut section faces the end section 21 in the front end of the stator core 22 in the axial direction, and the space that is enclosed with a recessed bottom wall of the annular bath and the end section 21 is formed to be a housing space of the coil end 24 and the coolant oil 60.

In order that the coolant oil 60 does not leak between the cooling jacket 30 and the end section 21 in the front end of the stator core 22 in the axial direction, a space between the annular opening of the cooling jacket 30 and the end section 21 in the front end of the stator core 22 is arranged to be closely contacted each other so as to be made liquid-tight. The inner periphery of the stator core 22 has the opening of the slot as described above, and therefore the opening of an inner periphery of the slot is also made liquid tight with an appropriate seal material. For example, the opening of the inner periphery of the slot is closed with resins.

Likewise, the cooling jacket 32 is an annular member that also makes a liquid-tight space between the end section 23 in the front end of the stator core 22 in the axial direction in which the coil end 26 and coolant oil 60 are housed.

The coolant oil 60 is oil that has an electrical insulation property and also has a function of cooling the coil end 26 and a function of securing insulation between the winding wires in the coil ends 24 and 26 where plural winding wires are stacked. A supply port 28 that is provided in the cooling jacket 30 is an oil inlet where the coolant oil 60 is supplied to the side of the cooling jacket 30, and a discharge port 29 is an oil outlet where the coolant oil 60 that is supplied to the side of the cooling jacket 30 is circulated through the cooling jacket 30, the slot of the stator core 22, and the cooling jacket 32 and discharged to the outside.

In this embodiment, as the coolant oil 60 that is coolant, a lubricant that is referred to as ATF for lubricating a transmission system which is mounted in a vehicle can be used to circulate in the three-phase rotating electrical machine 10. In this case, the supply port 28 and the discharge port 29 are connected to a lubricant path in the transmission system (not shown).

An opening 40 that is provided in an upper end section of the cooling jacket 30 in +Z direction is a hole for passing the lead wires 52, 54, and 56 that are drawn from the coil end 24. The lead wires 52, 54, and 56 are drawn from the coil end 24 that is housed in the inside of the cooling jacket 30 to the outside through the opening 40.

The coolant oil 60 satisfies the cooling function and the insulation securing function when the coolant oil 60 is supplied to a part of the coil end 24, and therefore an oil level 61 of the coolant oil 60 is determined to be up to an upper end 25 of the coil end 24. Thus, when the opening 40 is provided above the upper end 25 of the coil end 24 and the lead wires 52, 54, and 56 are drawn from the opening 40, the coolant oil 60 does not overflow from the opening 40, and the lead wires 52, 54, and 56 can be easily drawn to the outside.

Incidentally, when an opening area of the opening 40 is too wide, the coolant oil 60 may leak from the opening 40 to the outside, and therefore the opening 40 preferably has as small a hole size as possible. Therefore, the lead wires 52, 54, and 56 are collected at one place in the opening 40 as a root section 50, drawn through the opening 40 to the outside with a sufficient length. The lead wires are then separated adequately to be connected to the external.

The rotating electrical machine 10 that is mounted in the vehicle may be inclined by vibration and the like during the travel of the vehicle. When the rotating electrical machine 10 is of the transverse-mounted type in which the output shaft is arranged in the horizontal direction, the coolant oil 60 may overflow from the opening 40 through the inclination of the rotating electrical machine 10 about the output shaft. In FIG. 3, the inclination angle θ is shown. When the opening 40 is inclined about the central axis 14 as a rotation center by the inclination angle θ, the height position h of the opening 40 with reference to the oil level 61 of the coolant oil 60 becomes a small value. Therefore, when the value h becomes zero or negative, the coolant oil 60 overflows from the opening 40.

Thus, the height position of the opening 40 is determined so that the coolant oil 60 does not overflow from the opening 40 when the rotating electrical machine 10 is inclined. The height position of the opening 40 can be determined in accordance with an outline of the annular shape of the cooling jacket 30, an outline of the coil end 24, and a limit inclination angle of the rotating electrical machine 10.

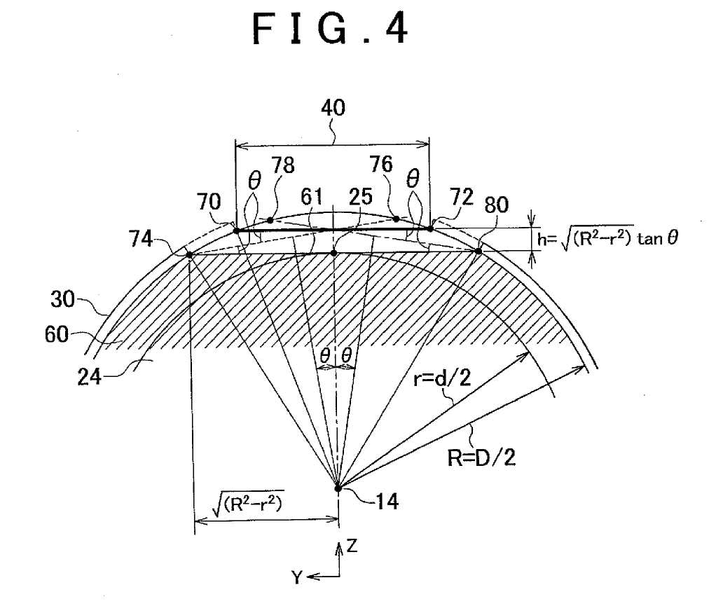

FIG. 4 is a schematic diagram that illustrates how to determine the height position of the opening 40 in an exemplified structure in which an outside diameter of the annular shape of the cooling jacket 30 is designated as a symbol D and a radius as a symbol R and an outside diameter of the annular shape of the coil end 24 is designated as a symbol d and a radius as a symbol r and in which the centers of the annular shapes respectively correspond to the central axis 14. On the assumption that the oil level 61 of the coolant oil 60 when the rotating electrical machine 10 is not inclined is determined to be the position of the upper end 25 of the coil end 24, FIG. 4 shows how the opening 40 inclines when the rotating electrical machine 10 is inclined.

FIG. 4 illustrates that the height position of the opening 40 when the rotating electrical machine 10 is not inclined is located at a position h above the upper end 25 of the coil end 24 that is determined as the oil level 61 as a reference position. Here, the term “above” means the +Z direction and a direction opposite to the direction of gravitational force. The height positions of the end sections of the opening 40 along the Y direction at that time, that is, the horizontal direction are shown as end positions 70 and 72.

As shown in FIG. 4, when the rotating electrical machine 10 is inclined at the inclination angle θ, a line connecting the end positions 70 and 72 of the opening 40 rotates about the central axis 14 by the angle θ. When the rotating electrical machine 10 is inclined by the angle θ in a counterclockwise direction on the sheet of FIG. 4, the height positions of the end sections of the opening 40 move to the end positions 74 and 76. As described above, in some cases, the height positions of the end sections of the opening 40 vary from the original height positions of the end sections, and one side of the end positions 74 and 76 moves downward to the oil level 61 of the coolant oil 60. In addition, when the rotating electrical machine 10 is inclined by the angle θ in a clockwise direction on the sheet of FIG. 4, the height positions of the end sections of the opening 40 move to the end positions 78 and 80. Here, the height positions of the end sections of the opening 40 also vary from the original height positions of the end sections, and another side of the end positions 78 and 80 may move downward to the oil level 61 of the coolant oil 60.

FIG. 4 shows an appearance when the height positions of the end sections of the opening 40 are just at the oil level 61 at the inclination angle θ. When the end sections of the opening 40 agree with the oil level 61 at the inclination angle θ, the original height position h of the opening 40 with reference to the oil level 61 is calculated as h=(R²−r²)^{1/2}×tan θ. Therefore, if the opening 40 is provided at a position where the height position h is positioned above the upper end 25 of the coil end 24 when the rotating electrical machine 10 is in a horizontal position, the coolant oil 60 does not overflow from, the opening 40 even if the rotating electrical machine 10 is inclined at the inclination angle θ.

In the above description, the cooling jacket 30 and the coil end 24 are formed in the annular shape that has the central axis as the concentric axis; however, the cooling jacket 20 may be arranged to be offset to the upper side with respect to the coil end 24. In addition, the cooling jacket 30, may be formed in the annular shape other than in a circular shape. In either case, the height position of the opening 40 can be determined in accordance with an outline of the annular shape of the cooling jacket 30, an outline of the coil end 24, and a limit inclination angle of the rotating electrical machine 10.

As described above, the opening 40 is provided at a predetermined height position in the cooling jacket 30, and therefore the lead wires 52, 54, and 56 can be drawn to the outside without overflow of the coolant oil 60. However, in order to achieve the above, the root sections 50 of the lead wires 52, 54, and 56 are required to be collected as described above.

Respective ends of the U-phase coil, the V-phase coil, and the W-phase coil are drawn at uniform angle spacings within a range of 30 degrees to 60 degrees of the angles along the circumferential direction about the central axis 14 in the coil end 24, depending the number of poles of the rotating electrical machine 10. For example, if three lead wires are drawn in an angular range of 45 degrees as they are, the size of the opening for passing the wires may become fairly large.

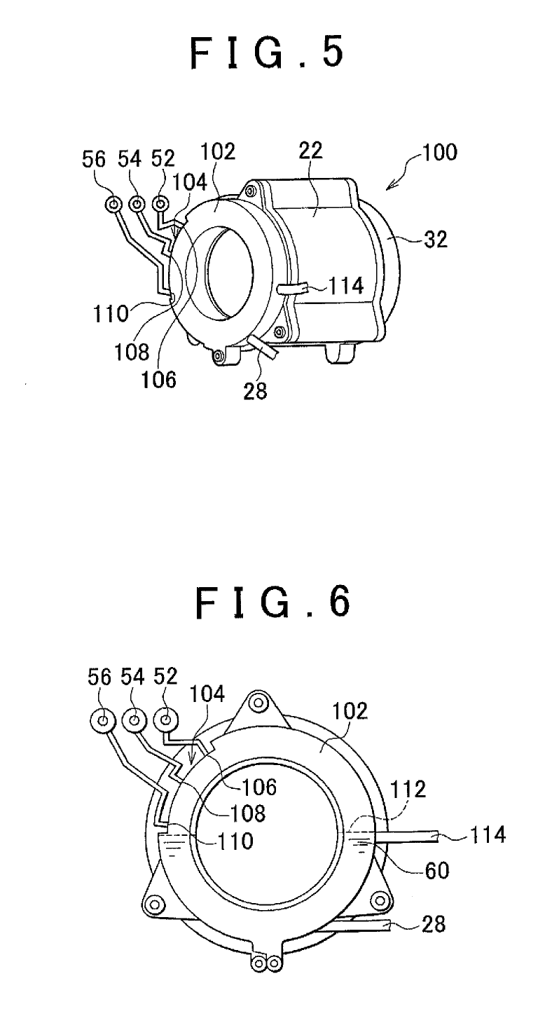

FIG. 5 and FIG. 6 show the appearances of a stator 100 when the respective ends of the U-phase coil, the V-phase coil, and the W-phase coil in the coil end 24 are not collected at the root sections but drawn to the outside as they are. FIG. 5 is a perspective view that corresponds to FIG. 1, and FIG. 6 is a side view that corresponds to FIG. 3.

In the stator 100, an opening 104 of a cooling jacket 102 is formed as a fairly large notch. The respective ends 106, 108, and 110 of the U-phase coil, the V-phase coil, and the W-phase coil in the coil end 24 are not collected at the root sections but can be drawn from the opening 104 that is a large notch as they are. Therefore, processing of the root sections of the lead wires 52, 54, and 56 from the coil end 24 of the stator core 22 is not necessary.

On the other hand, because the opening 104 is formed as a fairy large notch, oil level 112 where the coolant oil 60 does not overflow from the opening 104 lowers to a considerable extent. A discharge port 114 of the coolant oil 60 is also provided at a fairly low height position. Therefore, for the rotating electrical machine where requirements on a cooling performance and an insulation securing performance of the coil ends 24 and 26 are not so high, the structure as shown in FIG. 5 and FIG. 6 is effective.

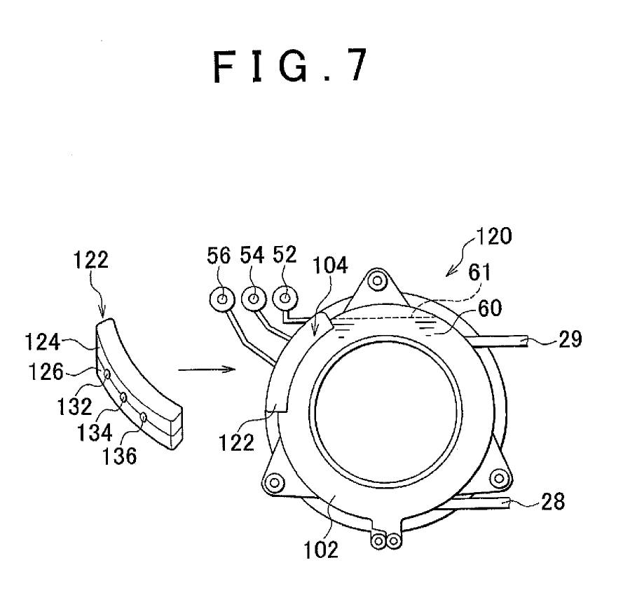

A stator 120 shown in FIG. 7 is provided with a seal 122 to the opening 104 shown in FIG. 5 and FIG. 6. The seal 122 is a lid member that has through holes 132, 134, and 136 for passing three lead wires 52, 54, and 56 and closes the opening 104. The seal 122 can be formed as a two-body structure that is separated into two bodies at a position of the through holes 132, 134, and 136. By providing the seal 122 to the opening 104 as described above, the oil level 61 of the coolant oil 60 can be achieved as the same level as those described with reference to FIG. 1 through FIG. 3.

The opening 40 that has a structure described with reference to FIG. 1 through FIG. 3 can also be provided with the seal 122 that is described with reference to FIG. 7 or equivalent, and therefore the overflow of the coolant oil 60 can be prevented further.

The rotating electrical machine according to the present invention can be used to a rotating electrical machine that provides cooling for the coil end.

The rotating electrical machine according to the present invention is summarized as follows.

The rotating electrical machine according to the present invention includes a rotor whose axis is disposed in a horizontal direction, a stator core that is disposed in an outside of the rotor, a coil that is wound in a slot which is provided along the axial direction of the stator core and, whose end sections of windings protrude from a front end and a rear end of the stator core in the axial direction as coil ends and whose one end of a winding wire is drawn as a lead wire to the outside, and an annular cooling jacket that makes a liquid-tight space between end sections in the front and rear end of the stator core in the axial direction in which the coil end and coolant oil are housed. The cooling jacket has an opening through which the lead wire of the coil is drawn to the outside and the opening is provided at a predetermined height position above an upper end of the coil end as a reference position.

In the rotating electrical machine according to the present invention, an oil level of the coolant oil may be determined to be at the upper end of the coil end.

In the rotating electrical machine according to the present invention, the height position h of the opening that is provided to the cooling jacket may be determined in accordance with an outer diameter D of an annular shape of the cooling jacket, an outer diameter d of the coil end, and a limit inclination angle θ of the rotating electrical machine.

The rotating electrical machine according to the present invention may have a lid that is fitted into the opening and has a hole for passing the lead wire.

According to the above structure, the rotating electrical machine includes an annular cooling jacket that is formed to be a liquid-tight space between the front end and the rear end of the stator core makes a liquid-tight space between end sections in the front and rear end of the stator core in the axial direction in which the coil end and coolant oil are housed. In addition, the cooling jacket is provided at a predetermined height position above an upper end of the coil end as a reference position and has an opening through which the lead wire of the coil is drawn to the outside. The coolant oil in the cooling jacket is provided for cooling the coil end, and therefore, when the opening is provided above the coil end for drawing the lead wire, the coolant oil does not overflow to the outside. With such the simple structure as described above, the lead wire of the coil can be drawn to the outside without the overflow of the coolant oil.

In the rotating electrical machine, because the oil level of the coolant oil is determined to be at the upper end of the coil end, insulation and cooling of the coil end are sufficiently achieved.

In the rotating electrical machine, because the height position h of the opening that is provided to the cooling jacket is determined in accordance with the outer diameter D of the annular shape of the cooling jacket, the outer diameter d of the coil end, and the limit inclination angle θ of the rotating electrical machine, the coolant oil is prevented from overflowing to the outside even when the rotating electrical machine is inclined.

Because the rotating electrical machine has a lid that is fitted into the opening and has a hole for passing the lead wire, the coolant oil is further prevented from overflowing to the outside.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A rotating electrical machine, comprising:
a rotor whose axis is disposed in a horizontal direction;
a stator core that is disposed in an outside of the rotor;
a coil that is wound in a slot which is provided along the axial direction of the stator core, whose end sections of windings protrude from a front end and a rear end of the stator core in the axial direction as coil ends and whose one end of a winding wire is drawn as a lead wire to the outside; and
an annular cooling jacket that makes a liquid-tight space between end sections in the front and rear end of the stator core in the axial direction in which the coil end and coolant oil are housed, wherein
the cooling jacket has an opening through which the lead wire of the coil is drawn to the outside and the opening is provided at a predetermined height position above an upper end of the coil end as a reference position.

2. The rotating electrical machine according to claim 1, wherein an oil level of the coolant oil is determined to be at the upper end of the coil end.

3. The rotating electrical machine according to claim 2, wherein the height position of the opening that is provided to the cooling jacket is determined in accordance with an outer diameter of an annular shape of the cooling jacket, an outer diameter of the coil end, and a limit inclination angle of the rotating electrical machine.

4. The rotating electrical machine according to claim 1, further comprising:
a lid that is fitted into the opening and has a hole for passing the lead wire.

5. The rotating electrical machine according to claim 1, wherein a plurality of the lead wires are collected at one position in the opening.
